(19) United States
(12) Patent Application Publication
(10) Pub. No.: US 2018/0374102 A1
(43) Pub. Date: Dec. 27, 2018

(54) CONTAINER AND CONTENT SERIALIZATION FOR SECURE PRODUCT IDENTIFIERS

(71) Applicant: INEXTO SA, Lausanne (CH)

(72) Inventor: Erwan FRADET, GRANDVAUX (CH)

(73) Assignee: INEXTO SA, Lausanne (CH)

(21) Appl. No.: 15/742,854

(22) PCT Filed: Sep. 21, 2016
(86) PCT No.: PCT/EP2016/072453

§ 371 Date: Jan. 8, 2018

Related U.S. Application Data
(60) Provisional application No. 62/222,771, filed on Sep. 23, 2015.

(51) Int. Cl. G06Q 30/00; H04L 9/08; H04L 9/32

(52) U.S. Cl. CPC G06Q 30/018; H04L 9/3213; H04L 9/0816

(57) ABSTRACT

This invention relates to a method of product identification and tracking. The invention allows for maintaining track of how many times a product or group of items can be and has been sub-divided and the ability to track an item back to its origin through the identification number assigned to it. The tracking can be done even if the product is combined with a new product and a new identification number is assigned.

This application claims the benefit of U.S. Provisional Application Ser. No. 62/222,771, filed Sep. 23, 2015, the contents which are herein incorporated by reference in its entirety.

The present invention relates generally to techniques for tracking and serialization of items as an item is subdivided or items or subparts are recombined to create larger parts.

Existing serialization methods generally only create numbering systems for the products that the system numbers. This has a shortfall if the product is later subdivided and is serialized again in that a whole new serialization must be created and generally does not fall into the original serialization method. This new serial number does not have a way of being directly traceable to the original serial number. Further complications arise if subcomponents are subsequently further divided or combined or both. These serialization tracking methods do not allow for easy identification of where the original component(s) came from if there is a need. This invention addresses these and other shortfalls with serialization of products.

The following embodiments of the invention are exemplary and are not intended to be limiting of the scope of the invention. While one or more embodiments of the present invention have been described, various alterations, additions, permutations and equivalents thereof are included within the scope of the invention. In the following description of embodiments, reference is made to the accompanying drawings that form a part hereof, which show by way of illustration specific embodiments of the claimed subject matter. It is to be understood that other embodiments may be used and that changes or alterations, such as structural changes, may be made. Such embodiments, changes or alterations are not necessarily departures from the scope with respect to the intended claimed subject matter. While the steps below may be presented in a certain order, in some cases the ordering may be changed so that certain inputs are provided at different times or in a different order without changing the function of the systems and methods described. Various computations that are described below, such as those within the code initialization, generation, and authentication procedures, need not be performed in the order disclosed, and other embodiments using alternative orderings of the computations could be readily implemented. In addition to being reordered, the computations could also be decomposed into sub-computations with the same results.

Embodiments of the invention will now be described, by way of example, with reference to the accompanying drawings, in which:

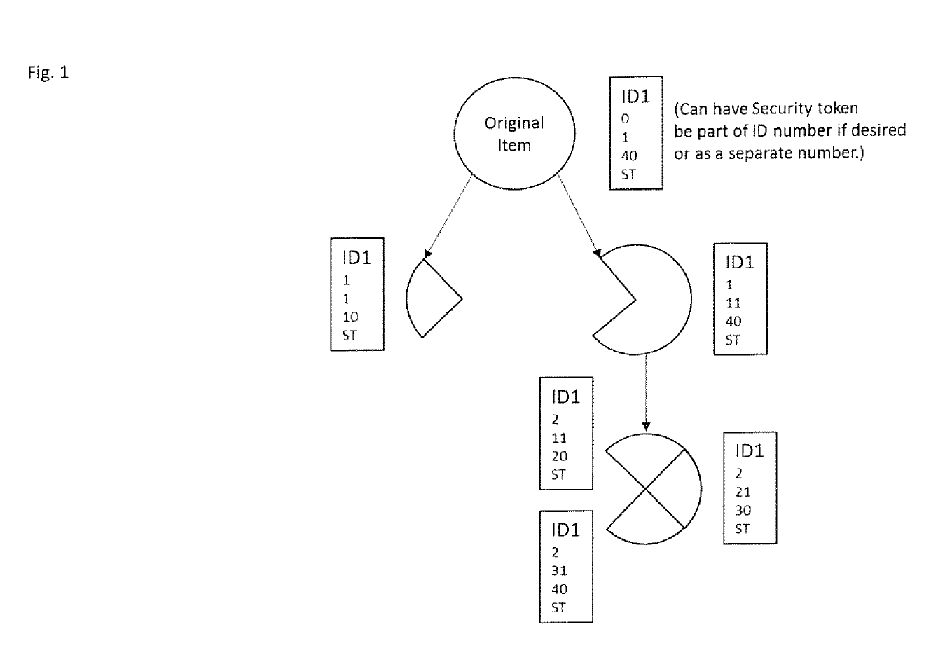

FIG. 1 illustrates an example of conversions from an original item to sub-items and then another conversion to further sub-items.

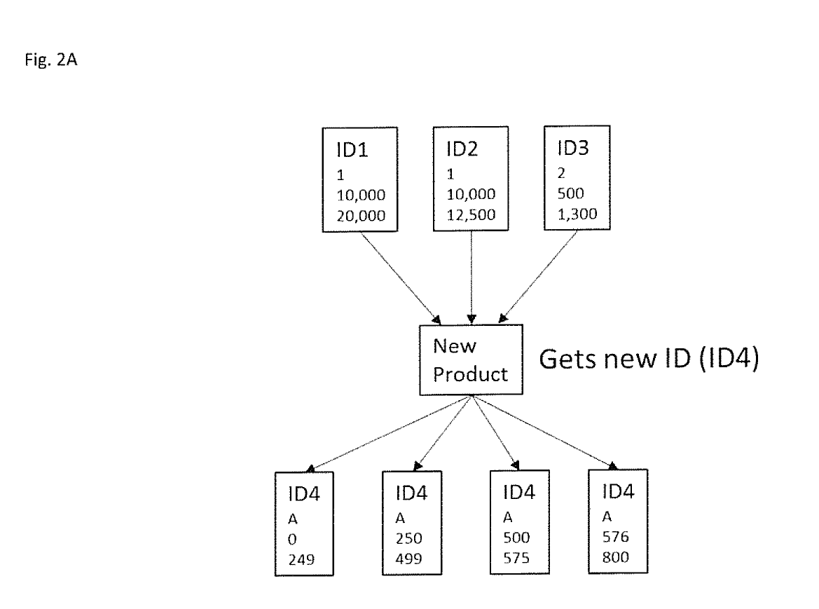

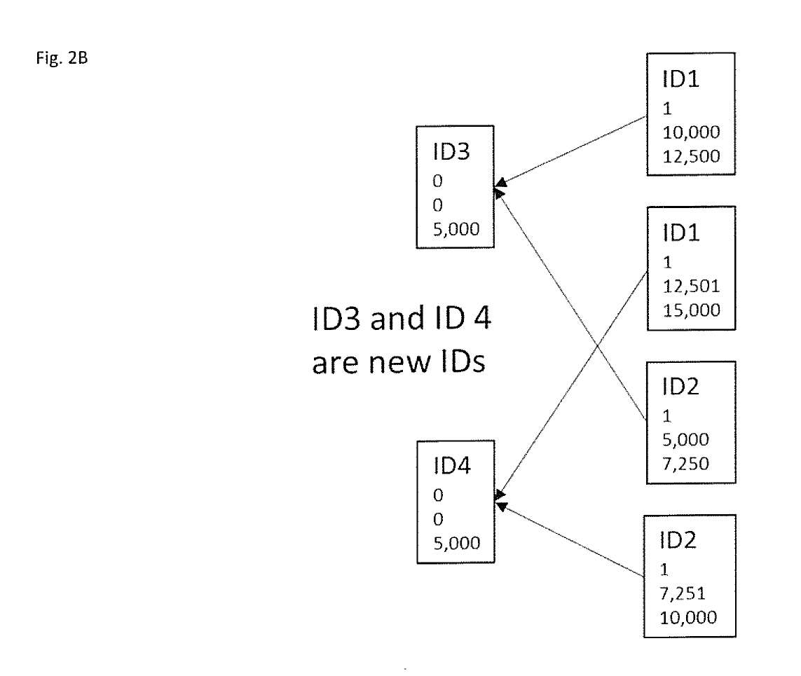

FIGS. 2A and 2B illustrate examples of combinations of items with different Identity (ID) numbers.

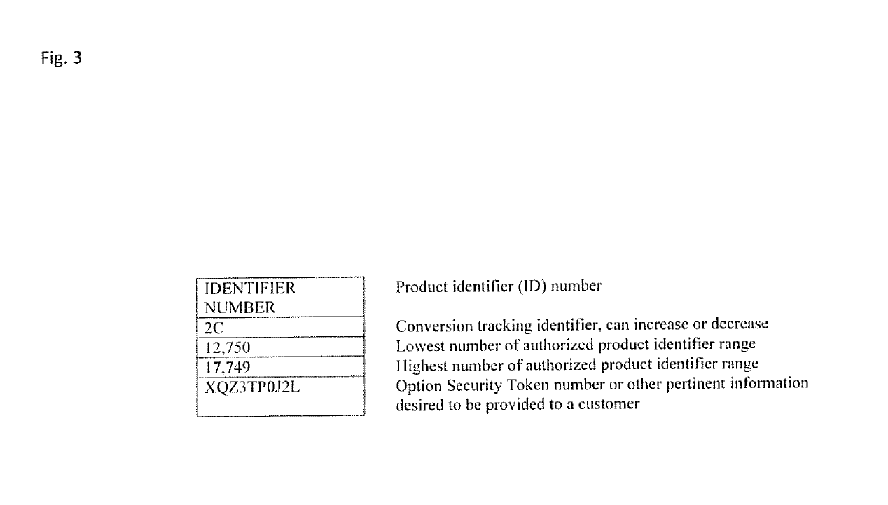

FIG. 3 illustrates example product labels with an alphanumeric conversion tracking identifier.

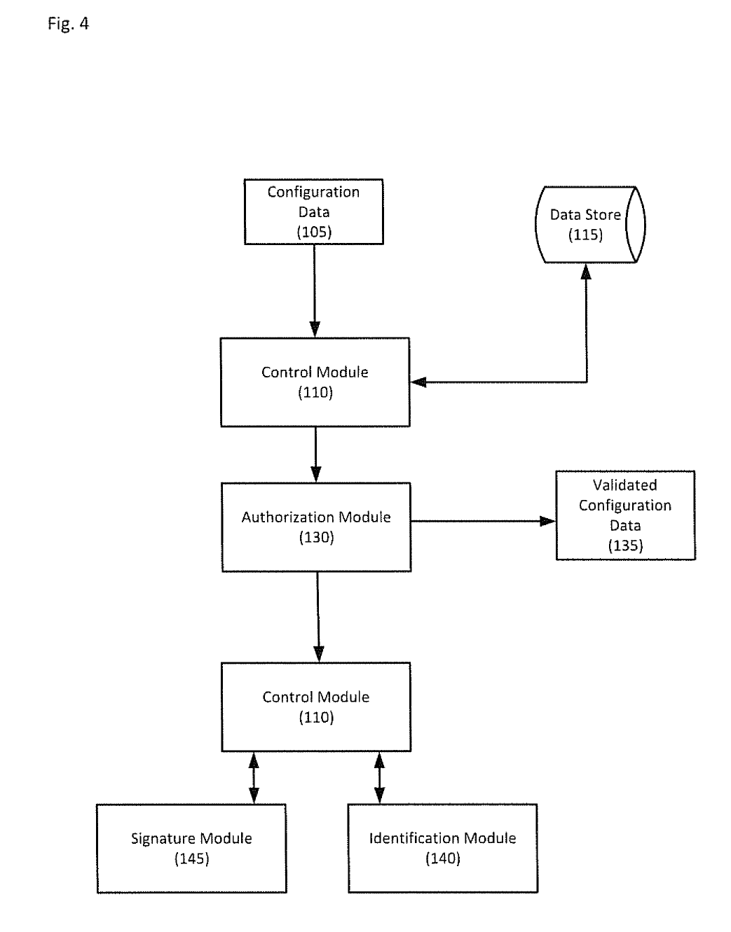

FIG. 4 illustrates an example method for code initialization.

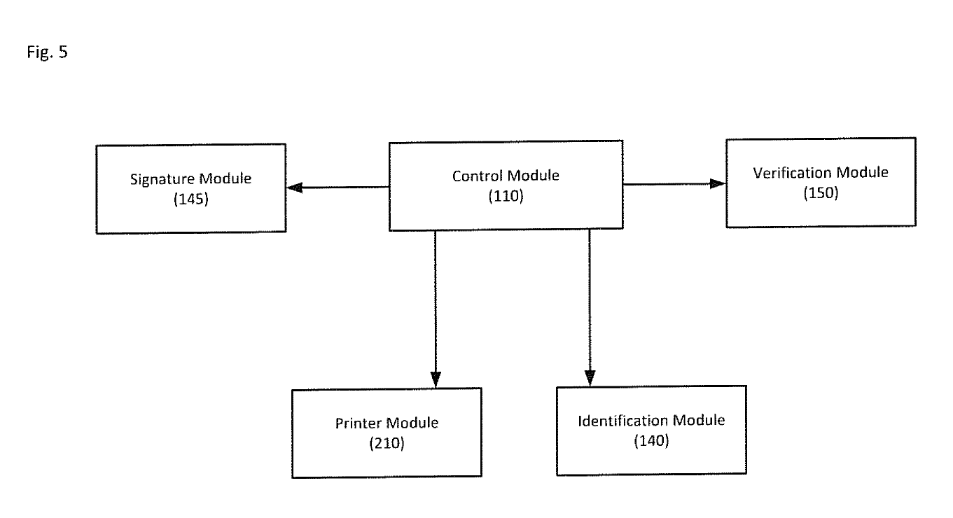

FIG. 5 illustrates an example method for code generation.

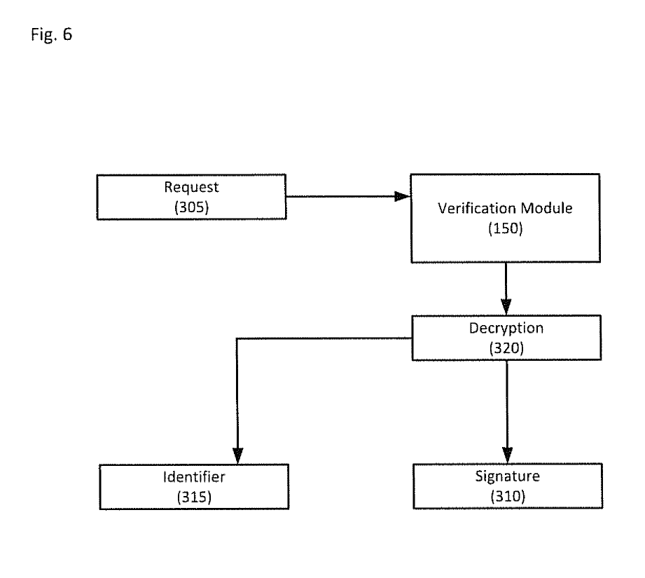

FIG. 6 illustrates an example method for code authorization.

The system and method described can be used in numerous fields, including any field in which products need to be tracked. This is especially useful in fields where items are divided and combined with other items to create new items. This is a common occurrence in the food and consumable industries. For example, a 40 kilogram block of cheese may be made. This block can then sub-divided into smaller blocks, for example a 10 kg block and a 30 kg block. This would be a first conversion. These may be further subdivided into smaller units, these being a second conversion, and then a third conversion, and so on. Alternatively, any subdivided part may be combined with another subdivided part from the same level. This may be counted as an additional conversion or as a reversion to the prior level of some of the components. This can occur with the original item being a 40 kilogram block of cheese. If in the second conversion that created this 40 kg block, S other blocks were created, and two such blocks are subsequently packaged together, it would result in a partial combination. Alternatively, the cheese may be used to make another product, and it would be helpful, or may be required, to track where all of the components of the product came from. It is useful for any industry in which multiple ingredients or components can be subdivided or combined to create or change goods.

According to some embodiments of the invention, the original block of cheese would be assigned an Identity number. This can include a security token as well that would identify where it was authorized for production or made. This is the original Identity for the product. It will also be assigned a generation number to it representative of how many times it has been subdivided or combined with other components. An original item when it is first obtained or created generally will have this number set to zero. As it is converted, e.g. subdivided, this number increases, the first conversion would yield a 1, second a 2, and so on. If it is not desired for a consumer to know exactly how many conversions have been applied to a product, a different numbering method can be used or a hash or encryption or some other method to hide the exact number from the customer, while the information is still maintained.

As illustrated in FIG. 1, an example label contains a product identification number, product range number, generation and space for other pertinent information. This label can include more information, such as a list of each of time or date the last modification was made, the location the modification was made, or other pertinent information. The label is generally attached to a product or can be printed or inscribed on a product.

At each conversion where the product number or range is to be changed or re-assigned, there must be a communication with a verification control (VC) module or a pre-approved method that is recorded at the VC module. This allows for tracking of individual products if the individual product numbers are changed.

Each generation also has a product number range assigned to it. Therefore, a product label should at the minimum have an Identity number, a generation indicator, and a product number. Alternatively, it can have a range of product numbers if more than one of a product are used. At each generation, the product number can be changed or be maintained. For example, starting with the 40 kg block of cheese, at the zero level, it may have 40,000 product numbers, each corresponding to a gram of cheese. This may be broken down on the first generation to two pieces, one with product numbers ranging from one to 10,000 and a second with product numbers ranging from 10,001 to 40,000. At the next conversion, the 10,001 to 40,000 block is further broken down into six 5,000 gram blocks, each maintaining number 10,001 to 15,000 then 15,001 to 20,000, and so on. This method allows for tracking of the original Identity number as well as the product number at each generation and as such, the tracking of the where the original block came from can be maintained.

In some embodiments, at each generation, the number could be reset. In this example, the Identity number is maintained, the generation number is increased, but the range, such as 10,001 to 15,000 is renumbered as 1 to 5,000 or any other range desired. This still allows for tracking back to the source for each of these batches. The Identity number is maintained and the generation information is also maintained, just the sub-component number is changed. This change in the numbering scheme would require contact with the VC module in order to record the renumbering for tracking purposes. It can also be used to maintain track of products where a unit is not authorized for individual resale and this can be used to identify products that are being used for purposes other than authorized. For example, a box of steak sauce bottles where the contents of the box are to be sold as a whole sale unit but are not authorized for subsequent individual resale. Scanning the label, or simple visual inspection of the label depending on what kind of identification scheme is used, would allow for differentiation between those authorized for retail sale and those that are not.

Similar to renumbering, when components are combined, the generational number is changed, and this change can be an increase or a decrease. In some embodiments where it is desired to maintain and show to the consumer how many times the item has been processed or changed, it can be increased. In others, it can be decreased or even reset to zero. It can be set to zero for any reason, such as indication of a “new original” product or a new company obtaining the material and working with it. However, each of these changes requires either or both a notification and authorization from the VC module.

In embodiments where components are combined, there are various options for maintaining the Identity number. If all of the subcomponents being recombined all have the same original Identity number, then the same Identity number can be maintained. In some embodiments, the system does not renumber the product numbers if they have not been changed at any of the previous conversions or divisions. However, if the product numbers have been changed, then a conflict could occur, such as two of the same product number. This would require a renumbering, which requires either authorization, or communication, or both with the VC module.

In the situations in which two or more products with different Identity numbers are combined, a new Identity number would be required. This can be achieved in the same manner as creation of the original Identity number through multiple authorization modules. The VC module sends the Identity numbers to each of the authorization modules associated with the Identity numbers, and obtains verification from each of these modules that modification of the components is authorized. This can be done in a serial or parallel setup. If done in serial, all of the Identity numbers and associated information is sent through for authorization, and each authorization module authorizes the component it can authorize, and waits for a response from downstream authorization modules. The last module to authorize the last Identity number returns the digitally signed authorization, and these are each digitally signed and combined with the upstream modules until the VC module receives a single authorization that is a combination of all the Identity numbers and digital signatures of the downstream authorization modules.

If a parallel or parallel and series set up is used, a similar systems arrangement can used. The authorizations are sent to the further downstream authorization units, which each digitally sign the authorizations and return them to upstream units, which combine and sign these and return them to the VC module. If the level below the VC module is a parallel connection and two or more authorization modules return a digitally signed authorization, the VC module can act as an authorization module and combine these two and digitally sign them to create the final ID to be used on the new product. Upon visual inspection, a customer may not be able to see the original product ID, however, the product ID is maintained and it can be tracked backwards if there is a need through the VC module. For example, if there are three ingredients to a wine blend, each ingredient, such as the three different types of grapes, have their own IDs. The new wine blend would receive its own ID, which is derived from the combination of the three original ingredient IDs by sending an authorization request from the VC to the subunits, each which would return a digitally signed authorization. These being combined and signed on each step up to create a single ID for the new product. The new ID will also have a range of product numbers associated with it based upon the authorized ranges the downstream authorization units allowed.

Referencing FIGS. 2A and 2B, all of the items to be combined have a conversion identifier of 1 prior to combination, the number could be increased to two, showing that it has been through two conversions, or reset to zero as shown. The zero can indicate that multiple products with the same or different numbers have been combined or that it is a new original product. The number need not be linear, for example, if it is known how many times all of the prior items have been combined, e.g. ID1 has been converted three times, ID2 two times, and they have been combined and the combined item with ID3 has been converted twice, is combined with 1D4 which has been combined four times, then the last product ID5, could have the counter set to zero, or to 2 indicating two prior combinations, or be set to 11, indicative of all the prior conversions. Alternatively, if the configuration is to count the maximum number of conversions at each level, then 3>2 so count 3, then add 2, 5>4 so count would be set at 5, indicating the maximum number of conversions. Any method of tracking that is uniform can be used as long as it is reversible. With the assistance of the VC module, all of the above and other counting methods are tracked each time a counter change is made and as such is reversible.

Alternatively, the VC module may be programmed to execute the convolution of the numbers through iterative authorization for each of the IDs through the single module if it has so been pre-authorized to do so. This step also authorizes the ranges for the product numbers to be authorized as well.

This system can also include an identification module. This module can be used to record the unique IDs each time one is created and from which component IDs it was created from and also its corresponding product number ranges. The ranges can be determined from, or limited by, the number of product number ranges in the components. For example, if two components are combined, one as a range of 101 to 125, and the other 50 to 550, the lower range can be used to limit the new product range to 25 units. Alternatively, the ranges may be disregarded and a whole new range can be created. In this example, the correspondence between the prior and post converted range numbers would be recorded and maintained as well when the new ID(s) was created and authorized.

This system can also be used for volume control of subdivision of products. Since the product number range associated with an ID is a finite span, it can be used to determine how many subunits can be made. All renumbering or any other changes to a product number range must be authorized by the VC module, the same as when two component ID units are combined. For example, if the product range is 1 to 1,000, and it is known that each finally packaged good will have 5 products in it, then it is known that no more than 200 packages can be created. This can be used to determine if counterfeit products have been created or there have been unauthorized changes to the range or number of products created.

According to an embodiment of the invention for item tracking, the method comprises: using a computerized processor, generating a product identification number from a verification module for an original item, wherein the identification number indicates a permissible quantity, weight, or volume derived from the verification control module; associating the product identification number with the original item; associating the product identification number with a conversion tracking identifier indicating a numerical value for how many times the original item can be subdivided or combined with another item; associating the product identification number with a range of product numbers into which the original product can be subdivided; verifying authorization for subdividing the original item by communicating the product identification number or a subdivided product identifier to the verification module; subdividing the original item into more than one subsequent items, the subdividing performed such that each subsequent item having a new range of product numbers that comprises a non-overlapping subset of product numbers of the original item range and not changing the product identification number; and incrementing the conversion tracking identifier.

According to an alternative or additional embodiment, the new range of product numbers is defined by a lower bound, upper bound, and noise. According to an alternative or additional embodiment, the new range of product numbers is secured. According to an alternative or additional embodiment, the method further comprises verifying the new range of product numbers at a label printer, the label printer being communicatively linked with an authorization module to verify production of items. According to an alternative or additional embodiment, a subsequent item is again subdivided. According to an alternative or additional embodiment, the range of product numbers of the subsequent product is a single number. According to an alternative or additional embodiment, a verification control module authorizes a change in any one or more of the range of product numbers and conversion tracking numbers associated with an original item or a subsequent item. According to an alternative or additional embodiment, a verification control module authorizes a change in the range of product numbers associated with an original item or a new item. According to an alternative or additional embodiment, authorization must be acquired from a verification control module prior any one or more of combination, subdivision, change in range of product numbers and conversion tracking identifier. According to an alternative or additional embodiment, a verification control module records any actions said module authorizes.

According to an embodiment of the invention for generating a code for securely identifying products produced at a production facility, the system comprises a computerized processor configured for executing instructions for: electronically receiving configuration data from an electronic data store; electronically storing the configuration data for a production run, wherein the configuration data for the production run specifies parameters used in the production of products; transmitting the configuration data to an authorization module; at the authorization module determining whether the production run is authorized; generating validated configuration data comprising a key, a representation of a plurality of authorized product identifiers, and a security token; transmitting the validated configuration data to a signature module; at the signature module, signing the validated configuration data; at an identification module, receiving a request for a product identifier and generating a product identifier in response to the request, wherein generating the product identifier is performed by: using a computerized processor, generating a product identification number from a verification module for an original item, wherein the identification number indicates a permissible quantity, weight, or volume derived from the verification control module; associating the product identification number with the original item; associating the product identification number with a conversion tracking identifier indicating a numerical value for how many times the original item can be subdivided or combined with another item; associating the product identification number with a range of product numbers into which the original product can be subdivided; verifying authorization for subdividing the original item by communicating the product identification number or a subdivided product identifier to the verification module; subdividing the original item into more than one subsequent items, the subdividing performed such that each subsequent item having a new range of product numbers that comprises a non-overlapping subset of product numbers of the original item range and not changing the product identification number; incrementing the conversion tracking identifier; storing the new range of product numbers in an electronic data store as the product identifiers; transmitting the new range of product numbers from the identification module to a signature module; digitally signing the new range of product numbers at the signature module; and transmitting the digitally signed the new range of product numbers to a printer module.

Integration with Secure Production Systems

The systems and methods described above for verification can be used in combination with systems for generating secure identifiers for use with a production.

As used herein, an entity may refer to: i) a person, such as a consumer of a product; ii) a group, such as a group having a common interest, such as retailers; iii) a computing device; iv) a computing node in a networked system; v) a storage location, such as a memory storage unit storing a document; vi) a virtual point in a network, such as representing a business function within a business enterprise, and the like. Additionally, an entity may represent a point in a workflow, such as for authorization, which may be performed by a person responsible for that aspect of the workflow or a computing device which provides automated processing. The term entity is not meant to be limited to any one of these examples and may extend to other situations consistent with the concepts described herein.

Control Module

With reference to FIG. 4, the Control Module (also known as the “Orchestrator”) (110) can receive input from any of the other modules or outside sources and can provide instructions to the other modules in the system based on pre-configured programs and/or the operator inputs to it. It can also generate a dashboard summary of the system status.

Input to the Control Module can include any or all configuration data (105). The supplied configuration data can indicate any or all of the parameters including, but not limited to, machine for production, production line, factory, product to be produced, and volume of product. The configuration data may indicate what items (far example, products) are to be marked with the secure identifiers and how those items may be produced. The configuration data may indicate a range of products, such as starting and ending product identifiers. In some embodiments, the range can be a set of product identifiers. The configuration data may be provided by an operator of the system or be dynamically or automatically generated. The configuration data can include further executable instructions or an interpretable algorithm. The configuration data may be based on operator input or the output of a manufacturing execution system, or other centralized system for instructing how and what to produce.

The Control Module (110) can transmit the configuration data to any module, including but not limited to the AuthorizationModule (130), the Identification Module (140), and the Signature Module (145).

The Control Module can request authorization from the Authorization Module to execute a production operation. This process involves transmitting a request (including some or all of the configuration data) to the Authorization Module and receiving signed or encrypted configuration data. In some embodiments, the Authorization Module can return the configuration data to the Control Module, including a digital signature applied to that configuration data. The Authorization Module determines whether to authorize the request from the Control Module based on the data it receives. In addition, the information returned by the Authorization Module included in the Configuration data can be used to bound the codes generated with the authorization provided. As the data is signed by the Authorization Module, the system can be prevented from modifying the configuration data. As a non-limiting example, a modification of a request to produce one brand on in place of another may be controlled, allowed, or denied.

Authorizations received from the Authorization Module can also be transmitted to the Verification Module so that verification requests can be subsequently processed against those authorizations. The data transmitted to the Verification Module can include a secure identifier, as well as any of the configuration data. In some examples, the configuration data sent to the Authorization Module can include product range information.

The signed or validated configuration data can be the some or all of the set of input parameters of the Control Module, verified and validated by the Authorization Module, which remains in force during a production. A security token can be an output from the Authorization Module and/or an input parameter of the Control Module. The security token can be a proof that the product identifier corresponds to validated configuration data and therefore to an authorized production. The security token can be an input to the Signature Module to generate a signature for a single product identifier, or the signature of a single product identifier, or a product identifier itself, or a range of products or product identifiers. The security token can be a unique code, a random code, or a pseudo-random code. The security token can be any numerical, or alphabetic, or combination of numeric and alphabetic characters.

Authorization Module

The Authorization Module operates to validate requests for authorization to take an action in the identification system. In some embodiments, it can operate as a license manager.

The Authorization Module can receive the configuration data. The Authorization Module can also receive range and/or algorithm information. In some embodiments, the Authorization Module can receive input configuration data from the Control Module. The output range can optionally identify a range of products, machines, factories, ranges, or product volumes that are authorized. The output can also include range information and/or include an algorithm which comprises a set of executable or interpretable instructions that will be used to generate the security token. The Authorization Module can be centralized at the factory level or be decentralized on each production line, or a combination of both.

The Authorization Module can store and/or generate one or more encryption keys. In some embodiments, the key stored by the Authorization Module can be a private public encryption key according to a public key infrastructure (PKI). In some embodiments, the Authorization Module stores the only copy of the private key. In other embodiments, the Authorization Module is distributed across several instances which replicate the keys between them. In the case of PKI, the Authorization Module can output signed configuration data. In some embodiments, the Authorization Module can encrypt the configuration data and/or sign the configuration data output.

In some embodiments, the system is configured so that only the Authorization Module can read the secured input parameters of the Control Module, required for the generation of the security token. In some embodiments, the key is provided to the Authorization Module from another source.

The Authorization Module can be embodied as a hardware security module (HSM), or another type of physical computing device that safeguards and manages digital keys for strong authentication and providing cryptoprocessing. The Authorization Module functionality can be performed by a computer with an embedded board with an encryption key or PKI private key. The module can be equipped with features such that attempts to access the data will result in it being rendered unreadable or inaccessible.

If the input to the Authorization Module is a range and an algorithm, the Authorization Module can output an identity in the range of authorization and a security token of the identifier. For example, the output identity can be a range from 0 to 1,000 with a security token for each item in the range.

The Authorization Module can generate a key from any parameter used in the Control Module. In some embodiments, the Authorization Module may generate or derive a key from an existing key from any parameter used in the Control Module such that only a specific Authorization Module can use this key. The equipment and software implementing this public key technique can be embodied in an asymmetric cryptosystem.

The output of the Authorization Module can be information, such as the configuration data and, optionally, one or more security tokens, with a digital signature provided by the Signature Module. Alternatively, the output of the Authorization Module can be the configuration data encrypted to a key held by the Authorization Module. The output of the Authorization Module can be provided to the Control Module.

According to an embodiment, the method for authenticating a production of products includes electronically storing configuration data for a production run, wherein the configuration data for the production run specifies parameters used in the production of products; determining if the configuration data for the production run is authorized; if the production run is authorized: generating a security token and associating the token with the configuration data; and digitally signing the configuration data by generating a digital signature and associating the digital signature with the configuration data; receiving the digitally signed configuration data and the digital signature at a production machine; at the production machine, verifying the digital signature associated with the digitally signed configuration data; calculating a set of secure product identifiers based on the digitally signed configuration data; producing products in a production run according to the digitally signed configuration data; and printing the set of secure product identifiers on the products according to the digitally signed configuration data.

In an alternative or additional embodiment, the configuration data represents a range of products to be produced. In an alternative or additional embodiment, the configuration data represents a range of products, machines, factories, ranges, or product volumes that are authorized. Alternative or additional embodiments can include receiving a verification request, the request comprising a product identifier and determining if the configuration data for the production run is authorized by reference to a license manager. Alternative or additional embodiments can include generating a security token for a range of products; and associating the security token with the range of products.

Signature Module

With reference to FIGS. 2-4, the Signature Module can receive the configuration data, an authorization key, a security token or any combination of them, as well as a unique product identifier generated by the Identification Module. In some embodiments, the Signature Module may receive, in addition, one or more intrinsic machine and/or product characteristics, and/or product item characteristics. The Signature Module can create a digital signature based on any or all of those inputs, generally referred to herein as configuration data.

To generate the digital signature, in some embodiments, the Signature Module can first generate a digest or other representation of the configuration data. In some embodiments, the digest can be generated by calculating a cryptographic hash value of the configuration data according to a digital signature algorithm provided by the Signature Module executing the digital signature algorithm. As non-limiting examples, the hash may be calculated according to MDS, SHA-1, SHA-2, SHA-3/Keccak functions. The digest can then be encrypted using a private key obtained by the Signature Module to generate the digital signature.

In some embodiments, a digital signature may use a Public Key Infrastructure (PKI) technology to establish authenticity of configuration data. PKI systems use certificates and keys to identify entities, individuals, or organizations. The Authentication Module uses a private key to sign the configuration data and associates the configuration data with a certificate including the public key used by the Authentication Module.

A recipient module uses a public key to verify the digital signature and, thereby, the authenticity of the signed configuration data. Supporting technologies can be employed to establish other non-repudiation features, such as the time of signing and the status of the signing keys. The public key may be provided to the recipient entity directly, or by publication in an on-line repository or directory.

Identification Module

The Identification Module can receive the configuration data and generate identifiers for items to be marked. The Identification Module can receive a digital signature generated by the Signature Module that will be combined with the unique identifier to generate a compound unique identifier.

The identifiers can include, or be based on, the date and/or time of production of a product to be marked and the digital signature received from the Signature Module. In some embodiments, the secure identifiers generated can be unique or substantially unique. In some embodiments, the secure identifiers can be the security token.

In the case of ranges, the Identification Module can generate a range identifier and a set of identifiers within the generated range.

The identifiers created may be output to a print control module for direct printing on to a product or may be input to further processing to generate another code that is printed on product packaging.

Verification Module

With reference to FIG. 2, the Verification Module (150) can be configured to use the enhanced verification methods described above. The Verification Module can further be configured to receive the verified configuration data and, based on that validated configuration data, validate a request for authorization (305) for a factory, machine, product, or production volume reported. The inputs to the Verification Module can include any or all of the verified configuration data, output from the signature module, identifiers, security tokens, and/or range information. The Verification Module can generate information for an Authorization Module with these parameters in order to verify/validate a product identifier.

The Verification Module can generate a decryption (320) of the request, which includes one or more identifiers or ranges of identifiers (315) and signature data (310) including one or more security tokens.

If a security token is input to the Verification Module, the Verification Module can return information relating to the authorization, the configuration data, and/or ranges. If a single security token is used for a range of products, the security token can be provided to the Verification Module to verify parameters associated with the range of products, rather than individual products. This embodiment may be particularly useful in the context of export regulation.

System Processes

Identification Code Initialization

Identification Code Initialization can be performed to validate the authorization and the parameters. In some embodiments, for performance reasons, this can be performed once at the beginning of the production. With reference to FIG. 4, the Control Module (110) can access a data store (115) for additional parameters, or additional parameters can be provided to the module. The parameters and the configuration data, once signed by the Authorization Module (130), form the validated configuration data (135). The Control Module receives verified configuration data as described above, in response to its request to the Authorization Module (130).

The authorization can be an authorization to produce a product, or to mark a product with a certain ID, or both. The configuration data and the additional parameters are transmitted to the Authorization Module and are used by the Authorization Module to generate the security token. The Authorization Module can sign the configuration data and the additional parameters, forming the signed configuration data. As discussed above, the configuration data can specify a certain production run or other products and activities. The Authorization Module can generate an authorization block including a key, authorized identifiers, and security token. In some embodiments, the key may be generated by the Authorization Module, or may be provided to it. The Authorization Module can transmit the authorization block to the Control Module. The Control Module can transmit the validated configuration data and other information, such as a list of identifiers, a range of identifiers, and/or one or more security tokens, to the Signature Module (145). The Signature Module can sign the data and send the signed data and the signature to the Control Module. The Identification Module (140) can then receive from the Control Module an initialization block including the identifiers and/or ranges of identifiers for products.

An embodiment of the invention can include a method for initializing a process for securely controlling a production facility, comprising: electronically receiving configuration data from an electronic data store; electronically storing the configuration data for a production run, wherein the configuration data for the production run specifies parameters used in the production of products; transmitting the configuration data to an authorization module; at the authorization module: determining whether the production run is authorized; generating validated configuration data comprising a key, a representation of a plurality of authorized product identifiers, and a security token; transmitting the validated configuration data to a signature module; and at the signature module, signing the validated configuration data.

Alternative or additional embodiments can include determining if the configuration data for the production run is authorized; if the production run is authorized: generating a security token and associating the token with the configuration data; and digitally signing the configuration data by generating a digital signature and associating the digital signature with the configuration data.

Alternative or additional embodiments can include receiving the digitally signed configuration data and the digital signature at a production machine; at the production machine, verifying the digital signature associated with the digitally signed configuration data; and calculating a set of secure product identifiers based on the digitally signed configuration data.

Alternative or additional embodiments can include producing products in a production run according to the digitally signed configuration data; and printing the set of secure product identifiers on the products according to the digitally signed configuration data.

Alternative or additional embodiments can include determining whether the production run is authorized further comprises retrieving licensing data from a licensing server.

Identification Code Generation

With reference to FIG. 5 the Code Generation process generates the codes during the production process. The identification code generation process can begin with a request to the Identification Module (140) for an identifier or a range of identifiers, which are then returned to the Control Module (110). The identifiers are then sent to the Signature Module (145), which signs the identifiers and returns the signed identifiers to the Control Module. The Signature Module can receive a security token. In some embodiments, the Signature Module does not need to be controlled by external instructions and if any identification code is to be counted, the code can be linked to a single security token. The Signature Module can be controlled by the Authorization Module. The Control Module can then send the output data to print control in Printer Module (210). The output data sent to the print control may be encrypted before transmission. The configuration data, can be transmitted to the Verification Module (150) for the handling of subsequent verification requests.

An embodiment of the invention includes a method for generating a code for securely identifying products produced at a production facility, including electronically receiving configuration data from an electronic data store; electronically storing the configuration data for a production run, wherein the configuration data for the production run specifies parameters used in the production of products; transmitting the configuration data to an authorization module; at the authorization module: determining whether the production run is authorized; generating validated configuration data comprising a key, a representation of a plurality of authorized product identifiers, and a security token; transmitting the validated configuration data to a signature module; at the signature module, signing the validated configuration data; at an identification module, receiving a request for a product identifier and generating a product identifier in response to the request; transmitting the product identifier from the identification module to a signature module; digitally signing the product identifier at the signature module; and transmitting the digitally signed product identifier to a printer module.

Alternative or additional embodiments can include electronically receiving configuration data from an electronic data store; electronically storing the configuration data for a production run, wherein the configuration data for the production run specifies parameters used in the production of products; transmitting the configuration data to an authorization module; at an authorization module: determining whether the production run is authorized; generating validated configuration data comprising a key, a representation of a plurality of authorized product identifiers, and a security token; transmitting the validated configuration data to a signature module; at the signature module, signing the validated configuration data.

In alternative or additional embodiments, the request is for a range of identifiers. Alternative or additional embodiments can include determining if the configuration data for the production run is authorized; if the production run is authorized: generating a security token and associating the token with the configuration data; and digitally signing the configuration data by generating a digital signature and associating the digital signature with the configuration data.

Verification of Identification Code

As described above, the Verification Module (considered here in the singular as the serial or parallel relationships of multiple logical or physical Verification Modules) can receive a request for verification. The request can include one or more identification codes. The verification module can decrypt or otherwise deobfuscate the identifier code received. The resulting information, having been decrypted, can include a signature component and an identifier. The resulting identifier can then be linked against the original configuration data previously stored in association with the identifier. The linked data can include other identifiers in a range, a security token, and other information stored in connection with the production of the product bearing that identification code.

Some embodiments can include additional functionality for processing identifiers that are provided to the Verification Module based on the party requesting the verification of the code. Different parties can be provided with different means to access the Verification Module. For example, a retailer or other form of merchant, may be provided with a different portal or communication channel than a consumer. The retailer may also be required to authenticate itself to the Verification Module.

In some embodiments, the system can be configured so that a verification by a consumer results in an identifier being marked as having been verified. The system can be further configured to store those codes for which verification is requested by a consumer. Any subsequent requests for verification of those already-verified codes can be denied or otherwise processed differentially.

Export Functions

Embodiments of the invention can be applied in the context of code export to third-parties. Those embodiments can include an export function configured to generate a separate code for this purpose. The exported code can be generated by collecting one or more product identifiers and/or security tokens, and signing those identifiers and/or tokens. The identifiers and/or tokens can be collected at any point in the production process. The signed identifiers and/or tokens in the form of exported codes can be provided to a third party who can store them and perform verification of the validity of the identifiers and/or tokens.

System Architectures

The systems and methods described herein can be implemented in software or hardware or any combination thereof. The systems and methods described herein can be implemented using one or more computing devices which may or may not be physically or logically separate from each other. Additionally, various aspects of the methods described herein may be combined or merged into other functions. In some embodiments, the illustrated system elements could be combined into a single hardware device or separated into multiple hardware devices. If multiple hardware devices are used, the hardware devices could be physically located proximate to or remotely from each other.

The methods can be implemented in a computer program product accessible from a computer-usable or computer-readable storage medium that provides program code for use by or in connection with a computer or any instruction execution system. A computer-usable or computer-readable storage medium can be any apparatus that can contain or store the program for use by or in connection with the computer or instruction execution system, apparatus, or device.

A data processing system suitable for storing and/or executing the corresponding program code can include at least one processor coupled directly or indirectly to computerized data storage devices such as memory elements. Input/output (I/O) devices (including but not limited to keyboards, displays, pointing devices, etc.) can be coupled to the system. Network adapters may also be coupled to the system to enable the data processing system to become coupled to other data processing systems or remote printers or storage devices through intervening private or public networks. To provide for interaction with a user, the features can be implemented on a computer with a display device, such as a CRT (cathode ray tube), LCD (liquid crystal display), or another type of monitor for displaying information to the user, and a keyboard and an input device, such as a mouse or trackball by which the user can provide input to the computer.

A computer program can be a set of instructions that can be used, directly or indirectly, in a computer. The systems and methods described herein can be implemented using programming languages such as Flash™, JAVA™, C++, C, C#, Visual Basic™, JavaScript™, PHP, XML, HTML, etc or a combination of programming languages, including compiled or interpreted languages, and can be deployed in any form, including as a stand-alone program or as a module, component, subroutine, or other unit suitable for use in a computing environment. The software can include, but is not limited to, firmware, resident software, microcode, etc. Protocols such as SOAP/HTTP may be used in implementing interfaces between programming modules. The components and functionality described herein may be implemented on any desktop operating system executing in a virtualized or non-virtualized environment, using any programming language suitable for software development, including, but not limited to, different versions of Microsoft Windows™, Apple™ Mac™, iOS™, UniX™/X-Windows™, Linux™, etc.

Suitable processors for the execution of a program of instructions include, but are not limited to, general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

The processor may also include, or be operatively coupled to communicate with, one or more data storage devices for storing data. Such data storage devices can include, as non-limiting examples, magnetic disks (including internal hard disks and removable disks), magneto-optical disks, optical disks, read-only memory, random access memory, and/or flash storage. Storage devices suitable for tangibly embodying computer program instructions and data can also include all forms of non-volatile memory, including, for example, semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The systems, modules, and methods described herein can be implemented using any combination of software or hardware elements. The systems, modules, and methods described herein can be implemented using one or more virtual machines operating alone or in combination with each other. Any applicable virtualization solution can be used for encapsulating a physical computing machine platform into a virtual machine that is executed under the control of virtualization software running on a hardware computing platform or host. The virtual machine can have both virtual system hardware and guest operating system software.

The systems and methods described herein can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks that form the Internet.

One or more embodiments of the invention may be practiced with other computer system configurations, including hand-held devices, microprocessor systems, microprocessor-based or programmable consumer electronics, minicomputers, mainframe computers, etc. The invention may also be practiced in distributed computing environments where tasks are performed by remote processing devices that are linked through a network.

While one or more embodiments of the invention have been described, various alterations, additions, permutations and equivalents thereof are included within the scope of the invention.

1. A method for item tracking, the method comprising:
using a computerized processor, generating a product identification number from a verification module for an original item, wherein the identification number indicates a permissible quantity, weight, or volume derived from the verification control module;
associating the product identification number with the original item;
associating the product identification number with a conversion tracking identifier indicating a numerical value for how many times the original item can be subdivided or combined with another item;
associating the product identification number with a range of product numbers into which the original product can be subdivided;
verifying authorization for subdividing the original item by communicating the product identification number or a subdivided product identifier to the verification module;
subdividing the original item into more than one subsequent items, the subdividing performed such that each subsequent item having a new range of product numbers that comprises a non-overlapping subset of product numbers of the original item range and not changing the product identification number; and
incrementing the conversion tracking identifier.

2. The method of claim 1, wherein the new range of product numbers is defined by a lower bound, upper bound, and noise.

3. The method of claim 1, wherein the new range of product numbers is secured.

4. The method of claim 1, further comprising verifying the new range of product numbers at a label printer, the label printer being communicatively linked with an authorization module to verify production of items.

5. The method of claim 1 wherein a subsequent item is again subdivided.

6. The method of claim 1 wherein the range of product numbers of the subsequent product is a single number.

7. The method of claim 1 wherein a verification control module authorizes a change in any one or more of the range of product numbers and conversion tracking numbers associated with an original item or a subsequent item.

8. The method of claim 1 wherein, wherein a verification control module authorizes a change in the range of product numbers associated with an original item or a new item.

9. The method of claim 1 wherein authorization must be acquired from a verification control module prior any one or more of combination, subdivision, change in range of product numbers and conversion tracking identifier.

10. The method of claim 1 wherein a verification control module records any actions said module authorizes.

11. A system for generating a code for securely identifying products produced at a production facility, comprising a computerized processor configured for executing instructions for:
electronically receiving configuration data from an electronic data store;
electronically storing the configuration data for a production run, wherein the configuration data for the production run specifies parameters used in the production of products;
transmitting the configuration data to an authorization module;
at the authorization module:
determining whether the production run is authorized;
generating validated configuration data comprising a key, a representation of a plurality of authorized product identifiers, and a security token;
transmitting the validated configuration data to a signature module;
at the signature module, signing the validated configuration data;
at an identification module, receiving a request for a product identifier and generating a product identifier in response to the request, wherein generating the product identifier is performed by:
using a computerized processor, generating a product identification number from a verification module for an original item, wherein the identification number indicates a permissible quantity, weight, or volume derived from the verification control module;
associating the product identification number with the original item;
associating the product identification number with a conversion tracking identifier indicating a numerical value for how many times the original item can be subdivided or combined with another item;
associating the product identification number with a range of product numbers into which the original product can be subdivided;
verifying authorization for subdividing the original item by communicating the product identification number or a subdivided product identifier to the verification module;
subdividing the original item into more than one subsequent items, the subdividing performed such that each subsequent item having a new range of product numbers that comprises a non-overlapping subset of product numbers of the original item range and not changing the product identification number;
incrementing the conversion tracking identifier;
storing the new range of product numbers in an electronic data store as the product identifiers;
transmitting the new range of product numbers from the identification module to a signature module;
digitally signing the new range of product numbers at the signature module; and
transmitting the digitally signed the new range of product numbers to a printer module.

12. The system of claim 11, wherein the new range of product numbers is defined by a lower bound, upper bound, and noise.

13. The system of claim 11, wherein the new range of product numbers is secured.

14. The system of claim 11, further comprising verifying the new range of product numbers at a label printer, the label printer being communicatively linked with an authorization module to verify production of items.

15. The system of claim 11 wherein a subsequent item is again subdivided.
